(19) United States
(12) Patent Application Publication
(10) Pub. No.: US 2026/0332683 A1
(43) Pub. Date: Oct. 22, 2026

(54) APPARATUS AND METHOD FOR MULTI-PROTOCOL COMMUNICATION

(71) Applicant: Vertiv Corporation, Westerville, OH (US)

(72) Inventors: Sanket G. Pandit, Ahmedabad (IN); Putli Sharma, Maharashtra (IN)

(21) Appl. No.: 19/649,734

(22) Filed: Apr. 16, 2026

(30) Foreign Application Priority Data
Apr. 17, 2025 (IN) 202511037370

(51) Int. Cl. H04L 69/18

(52) U.S. Cl. CPC H04L 69/18

(57) ABSTRACT

The present disclosure relates to a multi-protocol communication apparatus and method for enabling bidirectional communication among heterogeneous communication protocols using a single integrated device. The apparatus includes a plurality of communication interfaces, each configured to support a distinct communication protocol, and a control unit operatively coupled to the communication interfaces. The control unit is configured to receive data from a first communication interface, identify the protocol of the received data, convert the data into a data format compatible with a second communication protocol, and transmit the converted data to a second communication interface. The apparatus supports protocols including power-line communication (PLC), Controller Area Network (CAN), RS-485, Ethernet, USB, and Bluetooth, and is suitable for datacenter, industrial automation, and IoT applications.

### CROSS-REFERENCE TO RELATED APPLICATIONS

The present application claims the benefit of India Provisional Application No. 202511037370 filed on Apr. 17, 2025, which is herein incorporated by reference in the entirety.

### TECHNICAL FIELD

The present disclosure relates generally to communication systems and interfaces, and, more particularly, to apparatuses and methods for enabling communication between devices operating on different communication protocols, including wired and wireless communication standards.

### BACKGROUND

Background description includes information that may be useful in understanding the present disclosure.

In modern digital and industrial environments, seamless communication between devices operating on different protocols may be essential in certain use cases. Communication adaptors play a role in enabling interoperability between such devices. However, conventional adaptors are often designed to support only a limited set of communication protocols, thereby restricting their applicability. For example, when a user needs to connect multiple devices, such as a newly acquired printer, an older scanner, and a modern smartphone, each using distinct communication protocols, compatibility challenges may arise. In such cases, the user may be forced to either replace existing devices with compatible alternatives or procure multiple adaptors, which may result in increased costs and a cluttered workspace.

In large-scale deployments, including datacenters, industrial automation systems, and power distribution systems, multiple communication protocols are commonly used for interfacing different components such as converters, rectifiers, user interfaces, inverters, and Internet of Things (IoT) devices. Existing solutions in such environments typically require multiple dedicated communication boards, each supporting a specific protocol. This approach leads to increased hardware complexity, design inefficiencies, and higher maintenance costs. Moreover, the inability of a single communication interface to support multiple protocols limits scalability and flexibility in these deployments.

The rapid evolution of communication technologies has further exacerbated these challenges. New communication protocols are frequently introduced, which may render previously compatible communication adaptors obsolete. As a result, users and enterprises may be compelled to frequently upgrade or replace adaptors, leading to additional costs and operational disruptions. The continued reliance on single-protocol adaptors also contributes to excessive wiring, increased power consumption, and logistical inefficiencies, particularly in environments that require high-speed and reliable data exchange.

Some existing solutions attempt to mitigate these issues by integrating multiple protocol interfaces within a single adaptor. However, such solutions may lack a unified control mechanism capable of facilitating seamless protocol conversion and bidirectional data exchange. Additionally, existing multi-protocol adaptors may experience latency issues, inefficient power utilization, and limited scalability, making them unsuitable for dynamic and high-performance communication networks.

Thus, there may be a need for improved approaches that address one or more issues above and that enable seamless protocol conversion and bidirectional data exchange, optimize data transfer between devices, and reduce hardware and operational complexities.

### SUMMARY

This summary is provided to introduce concepts related to communication systems and interfaces. More particularly, the disclosure relates to apparatuses and methods for enabling communication between devices operating on different communication protocols, including wired and wireless communication standards. This summary is not intended to identify key features or essential features of the claimed subject matter, nor is it intended to be used to limit the scope of the claimed subject matter.

In an aspect of the present disclosure, a multi-protocol communication apparatus is described. The apparatus may include a plurality of communication interfaces and a control unit. Each communication interface of the plurality of communication interfaces may be configured to communicate using a respective and distinct communication protocol. The control unit may be operatively coupled to the plurality of communication interfaces, and configured to: (i) perform protocol conversion between at least two of the distinct communication protocols, and (ii) enable bidirectional data transfer among the plurality of communication interfaces, whereby the apparatus enables communication among heterogeneous communication protocols using a single apparatus.

In at least one embodiment, the control unit is further configured to: (a) receive data from a first communication interface operating in accordance with a first communication protocol, (b) identify the first communication protocol associated with the received data, (c) convert the received data into a data format compatible with a second communication protocol different from the first communication protocol, and (d) transmit the converted data to a second communication interface operating in accordance with the second communication protocol.

In at least one embodiment, the plurality of communication interfaces includes at least two interfaces selected from the group consisting of a power-line communication (PLC) interface, a Controller Area Network (CAN) interface, an RS-485 interface, an Ethernet interface, a Universal Serial Bus (USB) interface, a Bluetooth interface, and a Joint Test Action Group (JTAG) interface.

In at least one embodiment, the control unit performs protocol conversion using protocol mapping parameters.

In at least one embodiment, the apparatus includes a storage unit operatively coupled to the control unit. The storage unit stores at least one of predefined protocol mapping parameters, dynamically updated protocol mapping parameters, and temporarily buffered data to accommodate communication interfaces operating at different data rates.

In at least one embodiment, the control unit is configured to dynamically allocate communication bandwidth among the plurality of communication interfaces based on real-time data traffic conditions.

In at least one embodiment, the real-time data traffic conditions include at least one of buffer occupancy, latency, throughput, error rate, or interface priority.

In at least one embodiment, the apparatus further includes a power regulation unit configured to supply regulated power to the control unit and the plurality of communication interfaces. The power regulation unit is configured to receive power from both a battery power source and a power-line communication input connector. Further, power from the battery power source and the power-line communication input connector is combined using a diode-OR configuration.

In at least one embodiment, the power regulation unit includes (i) an input filter configured to suppress electrical noise, (ii) an isolated flyback transformer configured to generate one or more isolated DC voltages, and (iii) at least one low-dropout voltage regulator configured to provide regulated supply voltages.

In at least one embodiment, the apparatus further includes a battery backup unit configured to provide power to the apparatus during interruption or fluctuation of an external power source.

In at least one embodiment, a power-line communication (PLC) interface of the plurality of communication interfaces is configured to receive communication signals and electrical power through a shared connector. The shared connector provides differential power-line communication signals and line power on common conductors.

In at least one embodiment, a power-line communication (PLC) interface includes a PLC modem configured to modulate and demodulate communication signals transmitted over a power line.

In at least one embodiment, the PLC interface includes a buffer line driver configured to condition differential power-line communication signals prior to processing by the PLC modem.

In at least one embodiment, an Ethernet interface of the plurality of communication interfaces includes at least one of: (i) a 10/100 Mbps Ethernet physical layer interface, or (ii) a USB-to-Ethernet bridge configured to support Gigabit Ethernet communication.

In at least one embodiment, an RS-485 interface of the plurality of communication interfaces is configured to support Modbus or other industrial serial communication protocols.

In at least one embodiment, a Controller Area Network (CAN) interface of the plurality of communication interfaces includes an isolated CAN transceiver configured for differential signaling.

In at least one embodiment, a Bluetooth interface of the plurality of communication interfaces is configured to provide encrypted wireless communication with an external device.

In at least one embodiment, the apparatus includes a real-time clock configured to generate time-stamped logs of communication events.

In at least one embodiment, the control unit includes a microcontroller configured to simultaneously manage multiple communication protocols.

In at least one embodiment, any of the plurality of communication interfaces is selectively configurable as a first communication interface or a second communication interface based on operational conditions.

In at least one embodiment, the control unit is configured to temporarily store received data prior to protocol conversion to accommodate communication interfaces operating at different data rates.

In another aspect of the present disclosure, a method for multi-protocol communication is described. The method includes the step of receiving, through a first communication interface of a multi-protocol communication apparatus, a data formatted in accordance with a first communication protocol. The method further includes the step of identifying, by a control unit of the apparatus, the first communication protocol of the received data. The method includes the step of converting, by the control unit, the received data into a data format compatible with a second communication protocol different from the first communication protocol. Finally, the method includes the step of transmitting, to a second communication interface of the apparatus, the converted data.

In at least one embodiment, the receiving and transmitting steps are performed bidirectionally between any two communication interfaces of the apparatus.

In at least one embodiment, the method further includes the steps of: (i) retrieving protocol mapping parameters from a storage unit to perform the converting step, and (ii) dynamically updating the protocol mapping parameters based on operational conditions.

In at least one embodiment, the method further includes the step of dynamically allocating communication bandwidth among multiple communication interfaces based on real-time data traffic conditions. The step of dynamically allocating communication bandwidth includes the sub-step of prioritizing communication over one interface while buffering data associated with another interface.

In at least one embodiment, the method further includes the steps of (i) temporarily storing the received data in storage prior to conversion, and (ii) generating a time-stamp associated with at least one of the received data or the transmitted data using a real-time clock.

In at least one embodiment, the first or second communication protocol is selected from the group consisting of power-line communication, Controller Area Network, RS-485, Ethernet, Universal Serial Bus, and Bluetooth.

In at least one embodiment, the step of receiving the data includes the sub-step of receiving a power-line communication signal over a conductor that simultaneously supplies electrical power to the apparatus.

In at least one embodiment, the step of identifying the first communication protocol includes the sub-step of analyzing at least one of data framing, header structure, interface-level indicators, or protocol-specific timing characteristics.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a block diagram of a multi-protocol communication apparatus, in accordance with an embodiment of the present disclosure.

FIG. 2 illustrates a multi-protocol signal diagram of a multi-protocol communication apparatus, in accordance with one or more embodiments of the present disclosure.

FIG. 3 illustrates a signal process flowchart in a multi-protocol communication apparatus, in accordance with one or more embodiments of the present disclosure.

FIG. 4 illustrates a flowchart of a method for multi-protocol communication in a multi-protocol communication apparatus, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

In accordance with one or more embodiments, the present disclosure relates to a multi-protocol communication apparatus and a method for multi-protocol communication, configured to enable data exchange between devices operating according to different communication protocols. The apparatus may be structured to address limitations associated with conventional communication adaptors that typically facilitate communication using only a limited set of communication protocols, thereby restricting interoperability among heterogeneous devices. As described herein, the multi-protocol communication apparatus may provide a single apparatus capable of performing bidirectional data transfer and protocol conversion between at least two of the distinct communication protocols, thereby reducing the need for multiple dedicated adaptors and enabling compatibility across diverse communication standards. For example, the apparatus may receive a data frame formatted according to a PLC protocol over a shared power-line conductor, convert that data frame into a format compatible with a CAN protocol, and transmit the converted frame to a CAN-connected device, all within a single apparatus. For instance, a first device operating according to a PLC protocol may transmit data to a second device operating according to an RS-485 protocol through the apparatus, and the second device may respond via the RS-485 interface, with the apparatus converting the response into a PLC-compatible format and transmitting it back to the first device. The multi-protocol communication apparatus may also be referred to as a multi-protocol adapter.

In at least one embodiment, the multi-protocol communication apparatus includes a plurality of communication interfaces, wherein each communication interface is configured to facilitate communication using a respective and distinct communication protocol. The plurality of communication interfaces may include, without limitation, a power-line communication (PLC) interface, a Controller Area Network (CAN) interface, an RS-485 interface, an Ethernet interface, a Universal Serial Bus (USB) interface, a Bluetooth interface, and a Joint Test Action Group (JTAG) interface. A control unit may be operatively coupled to the plurality of communication interfaces and may be configured to perform protocol conversion between at least two of the distinct communication protocols and to enable bidirectional data transfer among the plurality of communication interfaces. In some embodiments, the control unit performs protocol conversion using protocol mapping parameters, which may be predefined or dynamically determined during operation to optimize protocol conversion (e.g., based on a user-configured routing table or operational conditions detected at runtime, such as interface availability or traffic load). For example, a predefined protocol mapping parameter may include a fixed frame translation rule specifying how a PLC payload field maps to a CAN data field, while a dynamically determined parameter may include a routing rule updated at runtime based on detected interface availability or traffic load.

In one or more embodiments, the multi-protocol communication apparatus further includes a power regulation unit configured to supply regulated power to the control unit and the plurality of communication interfaces. The power regulation unit may include an input filter configured to suppress electrical noise, an isolated flyback transformer configured to generate one or more isolated DC voltages, and at least one low-dropout voltage regulator configured to provide regulated supply voltages. In at least one embodiment, the power regulation unit is configured to receive power from a plurality of power sources including a battery power source and a power-line communication (PLC) input, and to combine power from the plurality of power sources using a diode-based power combining configuration. Additionally, a battery backup unit may be provided to supply power to the apparatus during interruption or fluctuation of an external power source, thereby supporting continuous operation in applications such as datacenter panels, industrial automation systems, and Internet of Things (IoT) environments. The apparatus may further include a storage unit operatively coupled to the control unit, wherein the storage unit includes at least one of electrically erasable programmable read-only memory (EEPROM), flash memory, or a combination thereof, and stores protocol mapping parameters used during protocol conversion.

In at least one embodiment, the control unit is further configured to dynamically allocate communication bandwidth among the plurality of communication interfaces based on real-time data traffic conditions. Such real-time data traffic conditions may include, for example, buffer occupancy, latency, throughput, error rate, or interface priority. For instance, when buffer occupancy on a first communication interface exceeds a predefined threshold, the control unit may reduce bandwidth allocated to one or more other communication interfaces and increase bandwidth allocated to the first communication interface until the buffer occupancy falls below the threshold. Dynamic allocation of communication bandwidth may improve overall data transmission efficiency and reduce communication bottlenecks when multiple communication interfaces operate concurrently. In some embodiments, the multi-protocol communication apparatus further includes a real-time clock, which may be configured to generate time-stamped logs of communication events, thereby facilitating data tracking, diagnostics, and synchronization within networked communication environments.

In embodiments, the present disclosure further provides a method for multi-protocol communication. In one or more embodiments, the method includes receiving, through a first communication interface of the multi-protocol communication apparatus, a data formatted according to a first communication protocol, identifying, by the control unit, the first communication protocol of the received data, converting the received data into a data format compatible with a second communication protocol different from the first communication protocol, and transmitting the converted data to a second communication interface according to the second communication protocol. In at least one embodiment, the first communication interface includes a power-line communication (PLC) interface configured to receive communication signals over a conductor that also supplies electrical power to the apparatus. The method may enable bidirectional communication between devices operating on different communication protocols without requiring modification of the devices' existing communication frameworks. In some embodiments, the method further includes storing protocol mapping parameters in storage, dynamically updating such parameters, temporarily storing received data prior to conversion, and dynamically allocating communication bandwidth based on real-time data traffic conditions.

For better understanding, one or more embodiments of the present disclosure will now be described with respect to the earlier-mentioned figures.

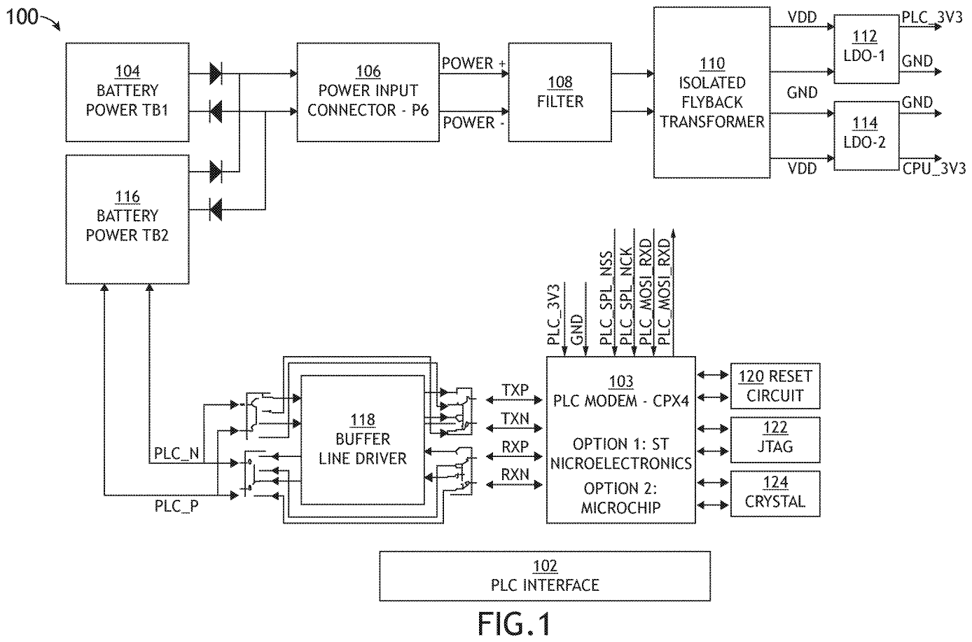

FIG. 1 illustrates a block diagram of a multi-protocol communication apparatus (100), in accordance with one or more embodiments of the present disclosure. As illustrated, the apparatus (100) may facilitate bidirectional data transfer between external devices operating according to different communication protocols by utilizing a control unit, a plurality of communication interfaces, and a power regulation unit. The components of the apparatus (100) may be arranged to enable protocol conversion between at least two of the distinct communication protocols, efficient power management, and reliable communication across heterogeneous interfaces, whereby the apparatus enables communication using a single apparatus.

In at least one embodiment, the plurality of communication interfaces includes interfaces configured to support PLC, CAN, RS-485, Ethernet, USB, Bluetooth, and/or JTAG protocols. Table 1 below illustrates representative hardware components corresponding to these protocols, including a PLC modem for PLC communication, a CAN transceiver chip for CAN communication, an RS-485 transceiver chip for Modbus-based communication, Ethernet physical layer interfaces for 10/100 Mbps communication, USB interfaces and USB-to-Ethernet bridge chips for Gigabit Ethernet communication, Bluetooth interface circuitry, and JTAG interfaces for debugging and programming. The PLC Modem may denote a functional communication module configured to enable data transmission over power line networks, including protocol processing, data buffering, and control logic implemented by a microcontroller. The PLC Transceiver may denote a physical-layer circuit within the PLC modem configured to interface with the power line medium and to perform modulation, demodulation, and differential signal transmission and reception. The specific components identified in Table 1 are examples only and the components may be substituted with any suitable functionally equivalent components in alternative embodiments.

TABLE 1

| Protocol | Hardware Components |
|---|---|
| PLC protocol | PLC transceiver chip |
| CAN protocol | CAN transceiver chip |
| RS-485 (Modbus) | RS-485 transceiver chip |
| Ethernet 10/100 Mbps | Ethernet PHY 10/100 Mbps |
| Bluetooth communication | UART to USB 1.0 bridge chip |
| USB 2.0 | USB interface |
| Ethernet 1 Gbps | USB 2.0 to Ethernet 1 Gbps bridge chip |
| JTAG | JTAG |

The control unit may include a microcontroller (not shown in FIG. 1) configured to simultaneously manage multiple communication protocols, perform protocol conversion using protocol mapping parameters, and enable bidirectional data transfer among the plurality of communication interfaces. The control unit may be operatively coupled to the communication interfaces and may be configured to receive data from a first communication interface operating according to a first communication protocol, identify the first communication protocol, convert the received data into a data format compatible with a second communication protocol, and transmit the converted data to a second communication interface operating according to the second communication protocol. In some embodiments, the control unit may be further configured to dynamically allocate communication bandwidth based on real-time data traffic conditions, including buffer occupancy, latency, throughput, error rate, or interface priority.

In at least one embodiment, the apparatus (100) may include a PLC interface (102) configured to facilitate communication (e.g., transmit digital signals) over a power line. The PLC interface (102) may include a PLC modem (103) configured to modulate and demodulate communication signals transmitted over the power line. The PLC interface (102) may be electrically coupled to a buffer line driver (118) configured to condition, amplify, and impedance-match differential PLC signals prior to processing by the PLC modem (103). The PLC interface (102) may be further coupled to a PLC signal input connector (116) configured to receive differential PLC signals, identified as PLC_P and PLC_N, from an external device.

In one embodiment, the PLC signal input connector (116) may be electrically coupled to a power input connector (106), enabling the PLC interface (102) to serve as an entry point for both communication signals and electrical power. In such embodiments, differential PLC communication signals and line power may be provided on common conductors, allowing coordinated signal reception and reference alignment for power integrity and communication reliability. Alternative embodiments may employ separate connectors for power and communication signals without departing from the scope of the present disclosure.

In embodiments, the apparatus (100) may further include a power regulation unit configured to supply regulated power to the control unit and the plurality of communication interfaces. In the illustrated embodiment, the power regulation unit may include the power input connector (106), which may receive Power+ and Power− signals from one or more external power sources, including a first battery power source coupled via terminal block TB1 (104) and a second battery or line-coupled power source coupled via terminal block TB2 (116). In at least one embodiment, power from the plurality of power sources may be combined using a diode-based power combining configuration, enabling redundancy and automatic switchover during power interruptions or fluctuations.

In at least one embodiment, the received power may be passed through an input filter (108) configured to suppress electrical noise and electromagnetic interference. The filtered power may be supplied to an isolated flyback transformer (110) configured to generate one or more isolated DC voltages, thereby providing galvanic isolation between the input power sources and internal circuitry. The isolated outputs of the flyback transformer (110) may be further regulated by low-dropout voltage regulators, including LDO-1 (112) and LDO-2 (114), to generate stable supply voltages for different power domains within the apparatus.

In one embodiment, LDO-1 (112) may generate a regulated PLC_3V3 supply referenced to ground, which may serve as the primary power rail for the PLC modem (103) and associated analog and digital PLC circuitry. In another embodiment, LDO-2 (114) may generate a regulated CPU_3V3 supply, which may power the control unit and other digital control circuitry. The separation of PLC_3V3 and CPU_3V3 power domains may improve noise immunity and operational reliability.

In at least one embodiment, the PLC modem (103) may be further coupled to a reset circuit (120) configured to ensure proper initialization, a JTAG interface (122) configured to support programming and debugging operations, and a crystal oscillator (124) configured to provide accurate clock signals for synchronized PLC communication. In alternative embodiments, the apparatus may include additional timing sources, storage units for storing protocol mapping parameters, or interface controllers without departing from the scope of the disclosure.

External devices may connect to the apparatus (100) using terminal blocks TB1 and TB2, the PLC signal input connector (116), or other interface-specific connectors corresponding to the plurality of communication interfaces. The integrated PLC modem subsystem, together with the power regulation architecture illustrated in FIG. 1, may enable the apparatus (100) to reliably receive, process, convert, and transmit communication signals across heterogeneous protocols in industrial, datacenter, and Internet of Things (IoT) environments.

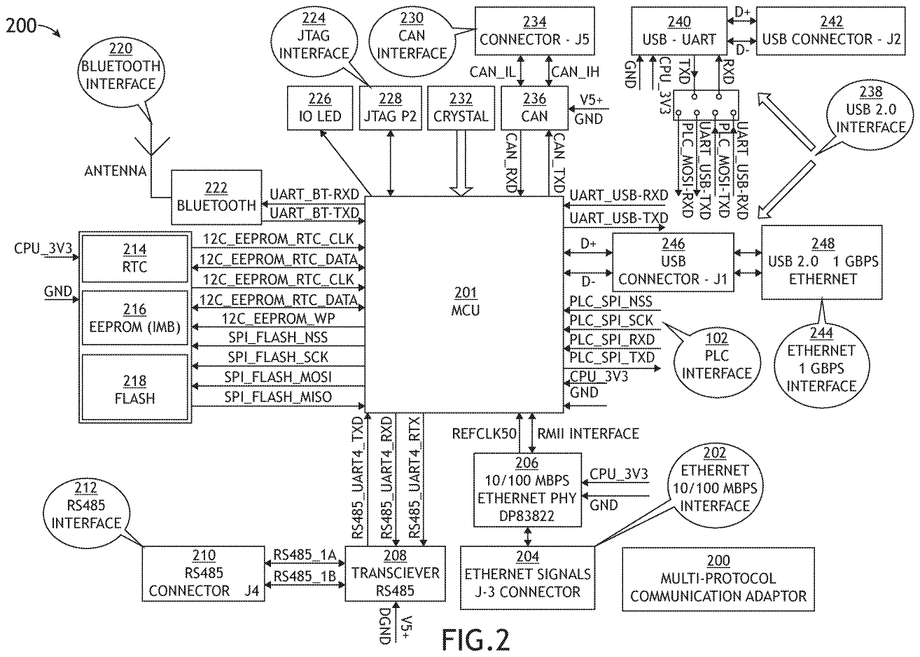

FIG. 2 illustrates a multi-protocol signal diagram of a multi-protocol communication apparatus (200), in accordance with one or more embodiments of the present disclosure. The multi-protocol communication apparatus (200), may be the same as, or share any components and/or other limitations with, multi-protocol communication apparatus (100) of FIG. 1. As illustrated, the signal diagram depicts how a plurality of protocol-specific communication interfaces, including PLC, CAN, RS-485, USB 2.0, Ethernet 10/100 Mbps, Ethernet 1 Gbps, and Bluetooth, are functionally integrated within a centralized architecture managed by a control unit (e.g., microcontroller (201)). This architecture may provide a scalable and adaptable communication framework suitable for datacenter environments, industrial automation systems, and multi-device networks.

In at least one embodiment, the control unit may include a microcontroller (201) that may operate as a centralized processing and coordination unit. The microcontroller (201) may be operatively coupled to the plurality of communication interfaces and may be configured to perform protocol conversion between at least two of the distinct communication protocols and enable bidirectional data transfer among the interfaces. The microcontroller (201) may manage real-time protocol conversion, data routing, memory access, and dynamic bandwidth allocation, thereby enabling seamless communication among heterogeneous protocols using a single apparatus.

In at least one embodiment, the PLC interface (102) may be configured to receive and transmit communication signals over power lines that carry both electrical power and data (e.g., digitally transmitted signals such as message packets (e.g., internet signals to a user device)). High-frequency filtering circuitry may be configured to separate low-frequency power components from high-frequency PLC communication signals received as differential signal pairs PLC_P and PLC_N from a power and signal entry connector. The PLC signals may be routed through a buffer line driver (118) configured to provide signal amplification, impedance matching, and line conditioning prior to processing by a PLC modem (103). The PLC modem (103) may include devices such as, but not limited to, R9A06G061GNPAAO, CPX4, ST8500, or PL360B, and may interface with the microcontroller (201) via serial communication protocols such as SPI or UART. Differential transmit and receive signal pairs TXP/TXN and RXP/RXN may enable reliable bidirectional PLC communication.

In at least one embodiment, the apparatus may include an Ethernet 10/100 Mbps interface (202) including an Ethernet physical layer (PHY) device (206) coupled to an Ethernet connector (204). The Ethernet PHY device (206) may support data communication using a Reduced Media Independent Interface (RMII) between the PHY and the microcontroller (201). In an alternative embodiment, relatively higher-speed networking may be supported through an Ethernet 1 Gbps interface (244) implemented using a USB 2.0 to Ethernet bridge (248), such as a LAN7500, AX88179, or RTL8153 device, with external connectivity provided through a USB connector (246). These Ethernet interfaces may enable the apparatus to function as a network gateway or bridge between Ethernet-based systems and other communication protocols.

In at least one embodiment, the apparatus may further include an RS-485 interface (212) including an RS-485 transceiver (208) coupled to an RS-485 connector (210). The RS-485 (212) interface is configured to support Modbus or other industrial serial communication protocols and manages differential RS485_1A and RS485_1B signals. The RS-485 interface (212) may enable bidirectional data exchange with industrial equipment, legacy systems, or field devices operating according to serial communication standards.

In at least one embodiment, the apparatus may include a CAN interface (230) including a CAN transceiver (236) coupled to an associated connector (234). The CAN interface (230) may support differential signaling using CAN_TXD and CAN_R×D lines and may provide galvanic isolation between the CAN bus and the microcontroller (201). The CAN interface (230) may be particularly suitable for automotive systems, industrial automation networks, and datacenter control applications requiring robust and noise-resistant communication.

In at least one embodiment, the apparatus may incorporate a USB 2.0 interface (238) implemented using a USB-to-UART bridge device (240), such as CP2102N-A02, coupled to a USB connector (242). The USB 2.0 interface (238) may support data communication over D+ and D-signal lines at speeds up to 480 Mbps, enabling data exchange with external devices and modules. In one embodiment, the USB 2.0 interface (238) may be utilized to support the Ethernet 1 Gbps bridge (248) via a separate USB connector (246), while in other embodiments, it may interface with external peripherals or configuration devices.

In at least one embodiment, the apparatus may support Bluetooth communication via a Bluetooth interface (220) including a Bluetooth module (222) (e.g., Bluetooth transceiver), such as OA14531MOO, operatively coupled to the microcontroller (201) through UART or SPI interfaces. The Bluetooth interface (220) may enable wireless communication with external devices, providing a flexible wireless alternative to wired communication protocols and supporting integration with Internet of Things (IoT) devices.

In at least one embodiment, the apparatus may further include system-level components including a real-time clock (RTC) unit (214) configured to generate time-stamped logs of communication events, a non-volatile storage unit including EEPROM (216) and SPI flash memory (218) for storing protocol mapping parameters, firmware images, and buffered data, and one or more JTAG interfaces (224, 228) for firmware programming, debugging, and maintenance. An I/O LED (226) may be provided to visually indicate operational status or communication activity. Clock synchronization across these communication interfaces may be maintained using a crystal oscillator (232) coupled to the microcontroller (201).

In at least one embodiment, the microcontroller (201) may be configured to receive data from a first communication interface, identify the associated communication protocol of the first communication interface, convert the received data into a data format compatible with a second communication protocol associated with a second communication interface, and transmit the converted data through the second communication interface. The microcontroller (201) may access protocol mapping parameters stored in the storage unit to perform protocol conversion and may dynamically update the parameters based on operational conditions. The microcontroller (201) may further dynamically allocate communication bandwidth among the plurality of communication interfaces based on real-time traffic conditions, thereby adjusting data flow and reducing latency.

The hardware components listed in Table 2 below represent example embodiments of the control unit, memory devices, communication interfaces, and peripheral components illustrated in FIG. 2. These components are provided for illustrative purposes only, and any suitable functionally equivalent components from other manufacturers or with different specifications may be employed in alternative embodiments without departing from the scope of the present disclosure.

TABLE 2

| Adaptor Component | Primary Component |
|---|---|
| Microcontroller | RSFS651EHOFP#30 |
| Flash Memory | MX2SL6433FM21-08Q |
| EEPROM Memory | M24M01-0WMN3TP/K |
| RTC | RX8010SJ |
| PLC Transceiver | R9A06G061GNPAAO |
| PLC Line Driver (Optional) | ISL151021RZ |
| CAN Transceiver | 15010SOOWR |
| UART to USB 2.0 Bridge | CP2102N-A02 |
| RS485 Converter | ISL8483EleZ-T |
| Ethernet 10/100 Mbps | DP83822 |
| USB 2.0 to 1Gbps Ethernet | LAN7500 |
| (External module) | |
| Bluetooth Module | OA14531MOO |
| Mechanical Module | Customize parts |
| Connector USB 2.0 | |
| Connector CAN | |
| Connector RS-485 | |
| Connector for Ethernet 10/100 | |
| Connector for PLC | |
| Ethernet 1 Gbps module | LAN7500/AX88179BQF/ |
| | AX88179X/RTL81S3e-VB-CG |

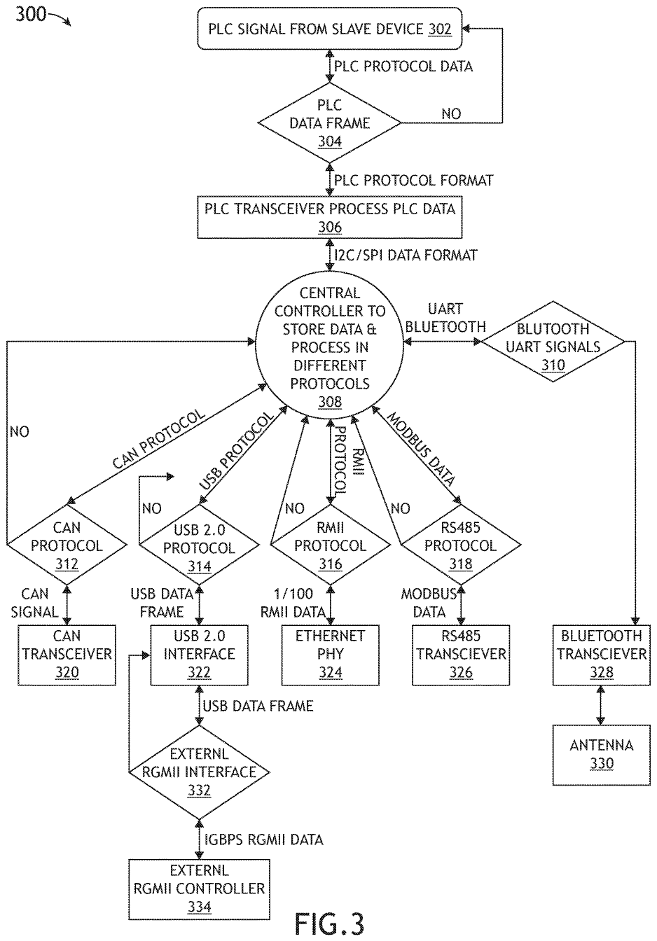

FIG. 3 illustrates a signal process flowchart (300) depicting the signal processing logic and protocol handling workflow executed by a multi-protocol communication apparatus (100, 200), in accordance with one or more embodiments of the present disclosure. The flowchart (300) represents functional operations performed by a control unit (201) operatively coupled to a plurality of communication interfaces, wherein the control unit (201) is configured to perform protocol conversion between at least two of the distinct (i.e., different) communication protocols and enable bidirectional data transfer among the plurality of communication interfaces, thereby enabling communication among heterogeneous communication protocols using a single apparatus.

In at least one embodiment, the signal process flowchart (300) illustrates how the control unit (201) may operate as a centralized processing entity that may manage bidirectional data flow, protocol identification, protocol conversion, memory interaction, and transceiver coordination across a plurality of communication interfaces. The plurality of communication interfaces may include, but are not limited to, a PLC interface, a CAN interface, a USB interface, an RS-485 interface, a Bluetooth interface, an Ethernet interface operating under RMII, and/or an Ethernet interface operating under a USB-based Gigabit Ethernet architecture.

This architecture may enable scalable and flexible communication suitable for industrial, embedded, datacenter, and multi-device network applications. Particularly, the plurality of communication interfaces may include the following:

A PLC interface (102) including a PLC modem (103) and a buffer line driver (118), enabling robust bidirectional communication over low-voltage AC or DC power lines while sharing conductors for power and data.

A CAN interface (230) including a CAN transceiver (236) configured to support ISO-compliant CAN communication, commonly used in industrial automation and automotive systems.

An RS-485 interface (212) including an RS-485 transceiver (208) for Modbus RTU or similar serial communication protocols.

An Ethernet interface, including both a 10/100 Mbps Ethernet PHY (206) operating under RMII and a USB-to-1 Gbps Ethernet bridge (248), facilitating wired network connectivity with high data throughput.

A USB interface (238) including a USB-to-UART bridge (240), supporting USB 2.0 standards.

A Bluetooth interface (220) incorporating a Bluetooth module (222) for secure short-range wireless communication.

A JTAG interface (224, 228) used for debugging, boundary scan testing, and firmware updates.

In at least one embodiment, at block (302) (e.g., step), signal processing begins when a signal formatted according to a first communication protocol is received by a first communication interface. In the illustrated embodiment, as an example, the first communication interface is a power-line communication interface configured to receive PLC signals from a slave device over a conductor that simultaneously supplies electrical power and communication signals. The apparatus may be configured to continuously monitor the PLC interface for incoming communication signals.

At block (304), the received PLC signal may be examined to determine whether the signal conforms to a valid PLC data frame. This validation may include analyzing signal framing, header structure, timing characteristics, checksum fields, or other protocol-specific indicators. If the received signal does not satisfy the validation criteria (e.g., a missing or malformed frame header, a checksum mismatch, or a timing deviation outside a protocol-defined tolerance), the process may be configured to return to block (302) to await receipt of a subsequent signal.

Upon successful validation of the PLC data frame, the process may be configured to proceed to block (306), wherein the validated signal may be processed by the PLC modem (103). In at least one embodiment, the PLC modem (103) may be configured to demodulate the received differential PLC signals and may extract payload data. Where a buffer line driver (118) is employed, differential signal pairs corresponding to transmit (TXP/TXN) and receive (RXP/RXN) paths may be used between the buffer line driver (118) and the PLC modem (103) to maintain signal integrity during bidirectional communication over the power line. The extracted data may then be forwarded to the control unit for further processing.

At block (308), the control unit may receive the extracted data from the PLC modem (103) and may determine how the data is to be processed, routed, or converted. In at least one embodiment, the control unit may identify the communication protocol associated with the received data and may determine whether protocol conversion is required. The control unit may temporarily store the data in a storage unit, including volatile or non-volatile memory, to accommodate differences in data rates, buffering requirements, or routing decisions.

In at least one embodiment, at block (310), the control unit (e.g., microcontroller (201)) may determine, based on a protocol condition, whether the data is to be transmitted via a Bluetooth interface. For example, the protocol condition may include a user-selected or preconfigured target protocol designation (e.g., a protocol type indicator or destination address field embedded in the received data frame that maps to the Bluetooth interface (220) in the protocol mapping parameters). If such a protocol condition is satisfied, the control unit may format the data into a Bluetooth-compatible format and may transmit the data to a Bluetooth module (328, 222) for wireless communication via an associated antenna (330). If the protocol condition is not met, control returns to block (308).

In at least one embodiment, at block (312), the control unit may determine whether the target protocol corresponds to a Controller Area Network protocol (e.g., based on a preconfigured or dynamically evaluated routing criterion, such as a protocol type indicator or destination identifier embedded in the received data frame). If so, the control unit may convert the received data into CAN-compatible frames using protocol mapping parameters and may forward the converted data to a CAN transceiver (320). If the CAN protocol condition is not met, the process returns to block (308).

In at least one embodiment, at block (314), the control unit may evaluate whether the data is to be transmitted using a Universal Serial Bus protocol (e.g., based on a preconfigured or dynamically evaluated routing criterion, such as a protocol type indicator or destination identifier embedded in the received data frame). If the condition is satisfied, the control unit may generate USB-compatible data frames and may route the data to a USB 2.0 interface (322). If the USB condition is not satisfied, control returns to block (308).

In at least one embodiment, at block (332), the control unit may determine whether the USB interface is coupled to an external USB-to-Ethernet bridge supporting Gigabit Ethernet communication. If such an interface is present, the USB data may be routed to the USB-to-Gigabit Ethernet bridge (334), enabling high-speed Ethernet transmission. Otherwise, the data remains routed through the USB interface.

In at least one embodiment, at block (316), the control unit may determine whether the data is to be transmitted using an Ethernet protocol operating under RMII (e.g., based on a preconfigured or dynamically evaluated routing criterion, such as a protocol type indicator or destination identifier included in a received data frame). If so, the control unit may forward the data to a 10/100 Mbps Ethernet physical layer interface (324). If the RMII condition is not satisfied, control returns to block (308).

In at least one embodiment, at block (318), the control unit may determine whether the data is intended for transmission via an RS-485 interface (e.g., based on a preconfigured or dynamically evaluated routing criterion, such as a protocol type indicator or destination identifier in the received data frame that maps to an RS-485-connected device). If identified as RS-485-compatible data, the control unit may format the data accordingly and may forward it to an RS-485 transceiver (326). If the RS-485 condition is not met, control returns to block (308).

In at least one embodiment, the signal process flowchart (300) may support bidirectional communication between any two communication interfaces managed by the apparatus. Any interface may operate as an input interface or an output interface based on operational conditions (e.g., an interface initially configured as an output interface may be reconfigured as an input interface upon detection of an incoming data frame, such as when an external device initiates communication with the apparatus), and the control unit may dynamically perform protocol conversion and routing accordingly.

In at least one embodiment, the control unit may analyze each received communication frame, may retrieve applicable protocol mapping parameters from storage, may convert the data into a compatible data format for a selected destination interface, and may initiate transmission through the corresponding transceiver.

In at least one embodiment, the control unit may dynamically allocate communication bandwidth among the plurality of communication interfaces based on real-time data traffic conditions, including buffer occupancy, latency, throughput, error rate, or interface priority.

In at least one embodiment, JTAG interfaces 224 may be employed during initialization, debugging, firmware updates, or fault recovery to support in-system programming and diagnostic operations.

Accordingly, FIG. 3 illustrates a signal flow for multi-protocol communication wherein the apparatus may receive a signal formatted according to a first communication protocol, may identify the protocol, may convert the received signal into a format compatible with a second communication protocol, and may transmit the converted signal through a second communication interface, thereby enabling real-time bidirectional communication using a single apparatus.

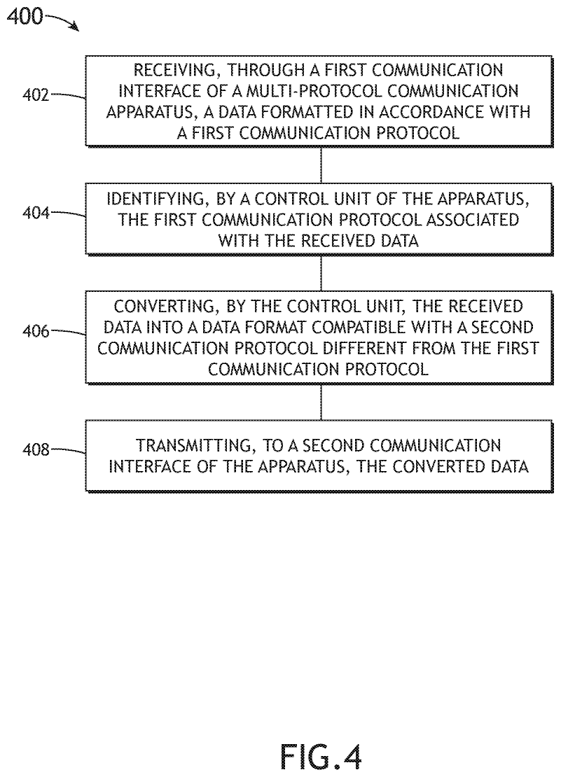

FIG. 4 illustrates a flowchart of a method (400) for multi-protocol communication performed by a multi-protocol communication apparatus (100, 200), in accordance with one or more embodiments of the present disclosure. The method represents firmware-executed operational logic carried out by a control unit operatively coupled to a plurality of communication interfaces, wherein the method may enable bidirectional communication between devices operating on different communication protocols using a single apparatus.

In at least one embodiment, the method (400) may be executed by a control unit including a microcontroller (201) configured to simultaneously manage multiple communication protocols. The control unit may cooperate with the plurality of communication interfaces to receive, identify, convert, and transmit communication data in real time. The method may be implemented as firmware instructions stored in non-transitory memory and executed during runtime.

At step (402), the method includes receiving, through a first communication interface of the multi-protocol communication apparatus, a data formatted according to a first communication protocol. The first communication interface may be any one of a PLC interface, a CAN interface, an RS-485 interface, an Ethernet interface, a USB interface, or a Bluetooth interface. In at least one embodiment, the received data may be a power-line communication signal received via a PLC interface over a conductor that simultaneously supplies electrical power and communication signals to the apparatus.

In at least one embodiment, the receiving step (402) may further include monitoring one or more communication interfaces for incoming data and detecting the presence of a valid communication frame. The received data may be temporarily buffered to accommodate differences in data rates among the plurality of communication interfaces.

At step (404), the method includes identifying, by the control unit, the first communication protocol of the received data. Protocol identification may be performed by analyzing at least one of data framing characteristics, header structure, interface-level indicators, protocol-specific timing behavior, or transceiver-level metadata. For example, the control unit may identify a received frame as belonging to a particular communication protocol based on a protocol-specific identifier or synchronization pattern present in the frame header. This identification may enable the control unit to determine whether protocol conversion is required.

In at least one embodiment, the identifying step (404) may include validating the received data for authenticity and integrity prior to further processing. If the data does not conform to the expected data format of the identified protocol, the control unit may discard the data or request retransmission.

At step (406), the method includes converting, by the control unit, the received data into a data format compatible with a second communication protocol different from the first communication protocol. In embodiments where the first communication protocol is a power-line communication protocol, the received PLC signal is first demodulated by a PLC modem prior to protocol conversion by the control unit. The control unit may perform protocol conversion using predefined or dynamically updated protocol mapping parameters stored in a storage unit operatively coupled to the control unit. For example, converting data from a first communication protocol to a second communication protocol may include extracting a payload from the received frame and repackaging the payload within a frame structure compatible with the second communication protocol, including at least one of (any required) protocol-required header fields, length indicators, and/or error-check fields.

In at least one embodiment, the converting step (406) may include temporarily storing the received data in storage prior to conversion to accommodate communication interfaces operating at different data rates. The protocol mapping parameters may include frame translation rules, header remapping tables, payload restructuring logic, and quality-of-service parameters (e.g., a rule specifying that a PLC data frame header is to be remapped to a CAN frame identifier field, or that a payload exceeding a defined byte threshold is to be segmented prior to transmission).

In at least one embodiment, the control unit may dynamically update the protocol mapping parameters based on operational conditions, including interface availability, traffic load, or detected errors. This may enable adaptive protocol translation without manual reconfiguration.

At step (408), the method includes transmitting, to a second communication interface of the apparatus, the converted data. The second communication interface may be the same type as, or different from, the first communication interface and may include any interface selected from the group consisting of PLC, CAN, RS-485, Ethernet, USB, and Bluetooth interfaces.

In at least one embodiment, the transmitting step (408) may include formatting the converted data into a protocol-compliant frame and forwarding the data frame to a corresponding transceiver or communication module for transmission to an external device.

In at least one embodiment, the receiving step (402) and transmitting step (408) may be performed bidirectionally between any two communication interfaces of the apparatus. Any communication interface may operate as an input interface or an output interface based on operational conditions.

In at least one embodiment, the method may further include dynamically allocating communication bandwidth among multiple communication interfaces based on real-time data traffic conditions, including buffer occupancy, latency, throughput, error rate, or interface priority.

In at least one embodiment, the method may further include generating a time-stamp associated with at least one of the received data or the transmitted data using a real-time clock unit, wherein the time-stamp may be stored for logging, diagnostics, or event correlation.

In at least one embodiment, the method may be executed while the apparatus is powered by a power regulation unit configured to receive power from a power-line communication input, a battery power source, or a combination thereof. Power from multiple sources may be combined using a diode-based configuration to support uninterrupted operation during power fluctuations. Accordingly, the described method may enable seamless, real-time, bidirectional communication among heterogeneous communication protocols using a single multi-protocol communication apparatus.

The disclosed multi-protocol communication apparatus and corresponding method may provide several technical effects and advantages over conventional communication adaptors and interface solutions.

In one technical effect, the apparatus may enable multi-protocol integration by supporting a plurality of distinct communication protocols, including, but not limited to, PLC, CAN, RS-485, Ethernet (10/100 Mbps and 1 Gbps), USB 2.0, and Bluetooth, within a single integrated adaptor device. By consolidating multiple protocol-specific interfaces into a unified hardware platform under control of a central controller, the apparatus may eliminate the need for separate, dedicated communication boards or adaptors, thereby reducing system complexity, physical footprint, and overall deployment cost.

Another technical effect is the provision of bidirectional communication among heterogeneous communication interfaces. The apparatus may enable bidirectional data transfer between devices operating under different communication protocols, allowing data to be received via a first interface, converted, and transmitted via a second interface, and vice versa. This capability may facilitate seamless interoperability in complex networked environments, such as datacenters and industrial systems, where multiple protocols must coexist and exchange information reliably.

A further technical effect is the ability to perform real-time protocol conversion. The control unit may be configured to convert data between at least two of the distinct communication protocols using predefined or dynamically updated protocol mapping parameters. In embodiments involving power-line communication, modulation and demodulation are performed by a dedicated PLC modem prior to protocol-level processing by the control unit. This real-time conversion capability may overcome protocol incompatibility barriers between heterogeneous devices and supports efficient data exchange in environments such as datacenter panels, industrial automation systems, power distribution networks, and communication infrastructure.

The apparatus may also provide the technical advantage of ease of deployment. The multi-protocol communication apparatus may be designed to be plug-and-play and may not require hardware modifications to existing system architectures. As a result, the apparatus may be readily deployed in legacy systems, including datacenters and industrial control installations, without replacing existing devices or rewiring communication networks.

Another technical effect is protocol agnosticism. By decoupling system operation from any single communication protocol, the apparatus may provide enhanced flexibility and scalability. This protocol-independent architecture may allow the system to accommodate evolving communication standards and newly introduced protocols, thereby extending the system's longevity and reducing the need for frequent hardware upgrades.

The disclosed apparatus may further achieve enhanced reliability and operational uptime. The integrated power regulation unit, which receives power from one or more external sources via a shared power entry interface and provides isolated and regulated voltage rails, may ensure stable power delivery to the control unit and communication interfaces. This configuration may enable uninterrupted communication during power disturbances, fluctuations, or outages, which may be needed in industrial applications.

Additionally, the apparatus may offer versatile applicability across a wide range of deployment scenarios. The multi-protocol communication capabilities make the apparatus suitable for use in datacenters, automation panels, smart grid communication systems, building management systems, and Internet of Things (IoT) networks, providing a robust and adaptable communication backbone across diverse platforms.

Finally, the inclusion of maintenance and debugging support provides a further technical advantage. The presence of one or more JTAG interfaces 224 may enable in-system debugging, firmware upgrades, and diagnostics, thereby improving maintainability, simplifying system updates, and reducing operational downtime.

Collectively, these technical effects demonstrate that the disclosed multi-protocol communication apparatus and method may provide a unified, reliable, scalable, and future-ready solution for enabling seamless communication among heterogeneous communication protocols using a single device.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried out in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A multi-protocol communication apparatus comprising:
a plurality of communication interfaces, each communication interface configured to communicate using a respective and distinct communication protocol; and
a control unit operatively coupled to the plurality of communication interfaces, and configured to:
perform protocol conversion between at least two of the distinct communication protocols; and
enable bidirectional data transfer among the plurality of communication interfaces,
whereby the apparatus is configured to enable communication among heterogeneous communication protocols using a single apparatus.

2. The apparatus of claim 1, wherein the control unit is configured to:
(a) receive data from a first communication interface operating in accordance with a first communication protocol;
(b) identify the first communication protocol associated with the received data;
(c) convert the received data into a data format compatible with a second communication protocol different from the first communication protocol; and
(d) transmit the converted data to a second communication interface operating in accordance with the second communication protocol.

3. The apparatus of claim 1, wherein the plurality of communication interfaces comprises at least two interfaces selected from the group consisting of a power-line communication (PLC) interface, a Controller Area Network (CAN) interface, an RS-485 interface, an Ethernet interface, a Universal Serial Bus (USB) interface, a Bluetooth interface, and a Joint Test Action Group (JTAG) interface.

4. The apparatus of claim 1, wherein the control unit performs protocol conversion using protocol mapping parameters, and wherein the apparatus further comprises a storage unit operatively coupled to the control unit, the storage unit being configured to store at least one of:
a. predefined protocol mapping parameters,
b. dynamically updated protocol mapping parameters, and
c. temporarily buffered data to accommodate communication interfaces operating at different data rates.

5. The apparatus of claim 1, wherein the control unit is configured to dynamically allocate communication bandwidth among the plurality of communication interfaces based on real-time data traffic conditions, the real-time data traffic conditions comprising at least one of buffer occupancy, latency, throughput, error rate, or interface priority.

6. The apparatus of claim 1, comprising a power regulation unit configured to supply regulated power to the control unit and the plurality of communication interfaces,
wherein the power regulation unit:
(a) comprises an input filter configured to suppress electrical noise, an isolated flyback transformer configured to generate one or more isolated DC voltages, and at least one low-dropout voltage regulator configured to provide regulated supply voltages;
(b) is configured to receive power from both a battery power source and a power-line communication (PLC) input connector; and
(c) is configured to combine power from the battery power source and the PLC input connector using a diode-OR configuration.

7. The apparatus of claim 1, wherein a power-line communication (PLC) interface of the plurality of communication interfaces is configured to receive communication signals and electrical power through a shared connector providing differential PLC signals and line power on common conductors,
and wherein the PLC interface comprises a PLC modem configured to modulate and demodulate communication signals transmitted over a power line, and a buffer line driver configured to condition differential PLC signals prior to processing by the PLC modem.

8. The apparatus of claim 1, wherein:
(a) an Ethernet interface comprises at least one of a 10/100 Mbps Ethernet physical layer interface or a USB-to-Ethernet bridge configured to support Gigabit Ethernet communication;
(b) an RS-485 interface is configured to support Modbus or other industrial serial communication protocols; and
(c) a Controller Area Network (CAN) interface comprises an isolated CAN transceiver configured for differential signaling.

9. The apparatus of claim 1, further comprising a real-time clock (RTC) unit configured to generate time-stamped logs of communication events,
wherein the control unit comprises a microcontroller configured to simultaneously manage multiple communication protocols,
wherein a Bluetooth interface is configured to provide encrypted wireless communication with an external device, and
wherein any of the plurality of communication interfaces is selectively configurable as a first communication interface or a second communication interface based on operational conditions.

10. A method for multi-protocol communication, comprising:
receiving, through a first communication interface of a multi-protocol communication apparatus, a data formatted in accordance with a first communication protocol;
identifying, by a control unit of the multi-protocol communication apparatus, the first communication protocol associated with the received data;
converting, by the control unit, the received data into a data format compatible with a second communication protocol different from the first communication protocol; and
transmitting, to a second communication interface of the multi-protocol communication apparatus, the converted data.

11. The method of claim 10, wherein the first communication protocol or the second communication protocol is selected from a group consisting of power-line communication, Controller Area Network, RS-485, Ethernet, Universal Serial Bus, and Bluetooth.

12. The method of claim 10, further comprising:
retrieving, by the control unit, protocol mapping parameters from a storage unit to perform the converting; and
dynamically updating the protocol mapping parameters based on operational conditions.

13. The method of claim 10, further comprising dynamically allocating, by the control unit, communication bandwidth among a plurality of communication interfaces of the multi-protocol communication apparatus, the plurality of communication interfaces including the first communication interface and the second communication interface, based on real-time data traffic conditions, the real-time data traffic conditions comprising at least one of buffer occupancy, latency, throughput, error rate, or interface priority.

14. The method of claim 13, wherein the dynamically allocating the communication bandwidth comprises prioritizing communication over one communication interface of the plurality of communication interfaces while buffering data associated with another communication interface of the plurality of communication interfaces.

15. The method of claim 10, wherein the receiving the data comprises receiving a power-line communication signal over a conductor that simultaneously supplies electrical power to the multi-protocol communication apparatus.

16. The method of claim 10, further comprising:
temporarily storing the received data in a storage unit prior to the converting to accommodate the first communication interface and the second communication interface operating at different data rates; and
generating a time-stamp associated with at least one of the received data or the converted data using a real-time clock.

17. The method of claim 10, wherein the identifying the first communication protocol comprises analyzing at least one of data framing, header structure, interface-level indicators, or protocol-specific timing characteristics of the received data.

18. The method of claim 10, wherein the receiving and the transmitting are performed bidirectionally between the first communication interface and the second communication interface, and wherein each of the first communication interface and the second communication interface is selectively operable as an input interface or an output interface based on operational conditions.

19. The method of claim 10, wherein the converting is performed using protocol mapping parameters, the protocol mapping parameters comprising at least one of frame translation rules, header remapping tables, payload restructuring logic, or quality-of-service parameters.

20. The method of claim 10, wherein the identifying further comprises validating the received data for conformance with an expected data format of the first communication protocol, and, responsive to the received data not conforming to the expected data format, discarding the received data or requesting retransmission.
